(19) United States
(12) Patent Application Publication
(10) Pub. No.: US 2018/0009001 A1
(43) Pub. Date: Jan. 11, 2018

(54) METHODS FOR THE VAPOR PHASE DEPOSITION OF POLYMER THIN FILMS

(71) Applicant: Massachusetts Institute of Technology, Cambridge, MA (US)

(72) Inventors: Adam T. Paxson, Cambridge, MA (US); David C. Borrelli, Cambridge, MA (US); Kripa K. Varanasi, Lexington, MA (US); Karen K. Gleason, Cambridge, MA (US)

(21) Appl. No.: 15/547,135

(22) PCT Filed: Jan. 29, 2016
(86) PCT No.: PCT/US2016/015658

§ 371 Date: Jul. 28, 2017

Related U.S. Application Data
(60) Provisional application No. 62/109,866, filed on Jan. 30, 2015.

(51) Int. Cl. B05D 1/00

(52) U.S. Cl. CPC B05D 1/60; B05D 2502/00; B05D 2506/10

(57) ABSTRACT

Disclosed are methods for forming thin polymeric films on a surface of an article by deposition from the vapor phase. In certain embodiments, the method comprises depositing the polymeric film in situ inside a space or enclosure contained within the article. In other embodiments, the method comprises depositing a film from vapor phase by thermal degradation of an initiator precursor without the need for an external filament.

### RELATED APPLICATION

This application claims the benefit of priority to U.S. Provisional Patent Application Ser. No. 62/109,866, filed Jan. 30, 2015; the contents of which are hereby incorporated by reference.

### BACKGROUND OF THE INVENTION

In many applications, the performance or durability of a device may be significantly improved by applying a functional coating or film on the device. For example, heat exchanger coatings are currently employed to mitigate corrosion and formation of scale and fouling deposits. Additionally, liquid-repellent heat exchanger coatings may also be used to promote dropwise condensation. These coatings often must be applied to extremely large surface areas, such as tubing bundles in shell-and-tube heat exchangers, heat exchanger plates, and finned surfaces. Current commonly-used methods for depositing coatings across large areas include dip-coating and spraying. However, these methods result in relatively thick films, typically greater than 1 μm in thickness, and sometimes as thick as 1000 μm, which presents a significant barrier to heat transfer because of the thermal resistance of the coating.

Ideally, it is more advantageous for a coating to be as thin as possible. For example, if the coating is to be used in a heat exchanger, then the coating will impose a certain thermal resistance proportional to the thickness of the coating. In certain high-flux applications, such as condensers and reboilers, a film even 1 μm thick will lead to significant reductions in heat transfer. As a second example, in applications in which a rough surface must be coated with a hydrophobic modifier, such as superhydrophobic, superoleophobic, or lubricant-infused surfaces, the special wetting properties of the surface rely on a finely textured surface whose characteristic length scale is often below 1 μm. Coatings deposited via e.g. spray-coating or dip-coating will lead to thick surfaces that completely cover the roughness features, thereby destroying the functionality imparted by the roughness. It is thus desirable to obtain a thin conformal coating that preserves the morphology of such a rough surface.

Chemical vapor deposition (CVD) is a technique commonly used to deposit very thin films, wherein a gaseous mixture of one or more components is introduced into a volume and is subsequently adsorbed onto target surfaces prior to forming a film. In some instances, after initial absorption, subsequent molecules from the gaseous mixture may react with the adsorbed molecules to polymerize and build a uniform film. This polymerization step may be accelerated by the use of a polymerization initiator, or by imparting additional energy to the system to help initiate polymerization. There are several variants of CVD, including plasma, photo-induced, and hot-wire techniques.

Hot-wire CVD (HWCVD) techniques, and variants including initiator chemical vapor deposition (iCVD), have been used to deposit thin organic films at low temperatures. One drawback of conventional iCVD approaches is the need to provide a heated filament adjacent to the substrate. See, for example, U.S. Patent Application Publication 2014/0314982 (incorporated by reference in its entirety). Since heat exchangers are commonly configured as enclosed bodies with complicated internal geometries, it is difficult to place filaments such that a uniform coating is applied to the desired surfaces.

One alternate to thermal degradation to initiate polymerization of vapor precursors is by plasma activation. For example, WO 2012/031862 (hereby incorporated by reference) discloses a technique for coating a condenser of a power plant using plasma-activated CVD, wherein the tube support plates are used as electrodes between which a plasma is generated. However, such a technique would require extensive modification of existing heat exchangers to provide the necessary electrical isolation between the tube sheets and the other components of the heat exchanger.

Other variants of CVD, such as parylene coatings, that do not require external filaments have been shown to lead to coatings that promote dropwise condensation. However, these coatings rely on chromium adhesion layers to survive under a steam environment. Furthermore, the coating process relies on flowing radical species, which have already been cleaved at high temperatures, into a target volume before coming into contact with the target surface. See for example, U.S. Pat. No. 3,342,754 (hereby incorporated by reference). It would, therefore, be difficult to coat complex geometries, such as a heat exchanger bundle, without providing extensive flow manifolds or the like.

Therefore, there is a need to have a method of coating surfaces that can deposit ultra-thin films onto complex surfaces that does not require a filament external to the surface and does not require extensive modification of the article.

### SUMMARY OF THE INVENTION

In one aspect, the present invention provides a method of depositing a coating, comprising the steps of: providing an article, wherein said article comprises an interior volume, an interior surface, and an exterior surface; introducing a gaseous mixture of reagents into the interior volume of the article, wherein said gaseous mixture contacts said interior surface, and said gaseous mixture comprises a unsaturated monomer; temporarily confining said gaseous mixture of reagents in the interior volume of the article; and applying heat to the gaseous mixture of reagents temporarily confined in the interior volume of the article, thereby depositing a coating on said interior surface.

In certain embodiments, the invention relates to any one of the aforementioned methods, wherein while temporarily confined in the interior volume of the article the gaseous mixture is heated to a temperature from about 50° C. to about 150° C.

In certain embodiments, the invention relates to any one of the aforementioned methods , wherein while temporarily confined in the interior volume of the article the gaseous mixture is heated to a temperature from about 60° C. to about 130° C.

In certain embodiments, the invention relates to any one of the aforementioned methods, wherein while temporarily confined in the interior volume of the article the gaseous mixture is heated to a temperature from about 70° C. to about 100° C.

In certain embodiments, the invention relates to any one of the aforementioned methods, wherein heat is applied to the confined gaseous mixture from the interior surface of the article.

In certain embodiments, the invention relates to any one of the aforementioned methods, further comprising heating the interior surface of the article prior to introduction of the gaseous mixture.

In certain embodiments, the invention relates to any one of the aforementioned methods, further comprising heating the gaseous mixture prior to introduction.

In certain embodiments, the invention relates to any one of the aforementioned methods, wherein the gaseous mixture is introduced from a single source.

In certain embodiments, the invention relates to any one of the aforementioned methods, wherein the gaseous mixture is introduced from a plurality of sources.

In certain embodiments, the invention relates to any one of the aforementioned methods, wherein prior to introduction into the interior volume of the article the temperature of the gaseous mixture is about 25° C. to about 50° C.

In certain embodiments, the invention relates to any one of the aforementioned methods, wherein prior to introduction into the interior volume of the article the temperature of the gaseous mixture is about 30° C. to about 45° C.

In certain embodiments, the invention relates to any one of the aforementioned methods, wherein while the gaseous mixture is confined in the interior volume of the article the pressure in the interior volume of the article is temporarily less than one atmosphere.

In another aspect, the present invention provides a method of depositing a coating, comprising the steps of: providing an article, wherein said article comprises an interior volume, an interior surface, and an exterior surface; and introducing a heated gaseous mixture of reagents into the interior volume of the article, thereby depositing a coating on said interior surface; wherein said heated gaseous mixture is introduced at a temperature from about 50° C. to about 350° C.; said heated gaseous mixture contacts said interior surface; and said heated gaseous mixture comprises a unsaturated monomer.

In certain embodiments, the invention relates to any one of the aforementioned methods, wherein the heated gaseous mixture is introduced at a temperature from about 50° C. to about 150° C.

In certain embodiments, the invention relates to any one of the aforementioned methods, wherein the heated gaseous mixture is introduced at a temperature from about 60° C. to about 130° C.

In certain embodiments, the invention relates to any one of the aforementioned methods, wherein the heated gaseous mixture is introduced at a temperature from about 70° C. to about 100° C.

In certain embodiments, the invention relates to any one of the aforementioned methods, further comprising heating the interior surface of the article prior to introduction of the heated gaseous mixture.

In certain embodiments, the invention relates to any one of the aforementioned methods, wherein the heated gaseous mixture is introduced from a single source.

In certain embodiments, the invention relates to any one of the aforementioned methods, wherein said single source is a heated inlet; and said heated inlet transfers heat to said heated gaseous mixture.

In certain embodiments, the invention relates to any one of the aforementioned methods, wherein said heated gaseous mixture is at ambient temperature prior to passing through said heated inlet.

In certain embodiments, the invention relates to any one of the aforementioned methods, wherein the heated gaseous mixture is introduced from a plurality of sources.

In certain embodiments, the invention relates to any one of the aforementioned methods, wherein the plurality of sources are heated inlets; and said plurality of heated inlets transfers heat to said heated gaseous mixture.

In certain embodiments, the invention relates to any one of the aforementioned methods, wherein said heated gaseous mixture is at ambient temperature prior to passing through said plurality of heated inlets.

In certain embodiments, the invention relates to any one of the aforementioned methods, wherein while the heated gaseous mixture is confined in the interior volume of the article the pressure in the interior volume of the article is temporarily less than one atmosphere.

In certain embodiments, the invention relates to any one of the aforementioned methods, further comprising the step of temporarily confining said heated gaseous mixture of reagents in the interior volume of the article.

In yet another aspect, the present invention provides a method of depositing a coating, comprising the steps of: providing an article and a housing; wherein said article comprises an exterior surface; said housing comprises an interior surface and an interior volume; and said article is positioned within said interior volume of said housing, thereby forming an interstitial volume between said exterior surface of said article and said interior surface of said housing; introducing a gaseous mixture of reagents into the interstitial volume, wherein said gaseous mixture contacts said exterior surface of said article, and said gaseous mixture comprises a unsaturated monomer; temporarily confining said gaseous mixture of reagents in the interstitial volume; and applying heat to the gaseous mixture of reagents temporarily confined in the interstitial volume, thereby depositing a coating on said exterior surface of said article.

In certain embodiments, the invention relates to any one of the aforementioned methods, wherein while temporarily confined in the interstitial volume the gaseous mixture is heated to a temperature from about 50° C. to about 150° C. In certain embodiments, the invention relates to any one of the aforementioned methods, wherein while temporarily confined in the interstitial volume the gaseous mixture is heated to a temperature from about 60° C. to about 130° C.

In certain embodiments, the invention relates to any one of the aforementioned methods, wherein while temporarily confined in the interstitial volume the gaseous mixture is heated to a temperature from about 70° C. to about 100° C.

In certain embodiments, the invention relates to any one of the aforementioned methods, wherein heat is applied to the confined gaseous mixture from the exterior surface of the article.

In certain embodiments, the invention relates to any one of the aforementioned methods, further comprising heating the exterior surface of the article prior to introduction of the gaseous mixture.

In certain embodiments, the invention relates to any one of the aforementioned methods, further comprising heating the gaseous mixture prior to introduction.

In certain embodiments, the invention relates to any one of the aforementioned methods, wherein the gaseous mixture is introduced from a single source.

In certain embodiments, the invention relates to any one of the aforementioned methods, wherein the gaseous mixture is introduced from a plurality of sources.

In certain embodiments, the invention relates to any one of the aforementioned methods, wherein prior to introduction into the interstitial volume the temperature of the gaseous mixture is about 25° C. to about 50° C.

In certain embodiments, the invention relates to any one of the aforementioned methods, wherein prior to introduction into the interstitial volume the temperature of the gaseous mixture is about 30° C. to about 45° C.

In certain embodiments, the invention relates to any one of the aforementioned methods, wherein while the gaseous mixture is confined in the interstitial volume the pressure in the interstitial volume is temporarily less than one atmosphere.

In yet another aspect, the present invention provides a method of depositing a coating, comprising the steps of: providing an article and a housing; wherein said article comprises an exterior surface; said housing comprises an interior surface and an interior volume; and said article is positioned within said interior volume of said housing, thereby forming an interstitial volume between said exterior surface of said article and said interior surface of said housing; introducing a heated gaseous mixture of reagents into the interstitial volume, thereby depositing a coating on said exterior surface of said article; wherein said heated gaseous mixture is introduced at a temperature from about 50° C. to about 350° C.; said heated gaseous mixture contacts said exterior surface of said article; and said heated gaseous mixture comprises a unsaturated monomer.

In certain embodiments, the invention relates to any one of the aforementioned methods, wherein the heated gaseous mixture is introduced at a temperature from about 50° C. to about 150° C.

In certain embodiments, the invention relates to any one of the aforementioned methods, wherein the heated gaseous mixture is introduced at a temperature from about 60° C. to about 130° C.

In certain embodiments, the invention relates to any one of the aforementioned methods, wherein the heated gaseous mixture is introduced at a temperature from about 70° C. to about 100° C.

In certain embodiments, the invention relates to any one of the aforementioned methods, further comprising heating the exterior surface of the article prior to introduction of the heated gaseous mixture.

In certain embodiments, the invention relates to any one of the aforementioned methods, wherein the heated gaseous mixture is introduced from a single source.

In certain embodiments, the invention relates to any one of the aforementioned methods, wherein said single source is a heated inlet; and said heated inlet transfers heat to said heated gaseous mixture.

In certain embodiments, the invention relates to any one of the aforementioned methods, wherein said heated gaseous mixture is at ambient temperature prior to passing through said heated inlet.

In certain embodiments, the invention relates to any one of the aforementioned methods, wherein the heated gaseous mixture is introduced from a plurality of sources.

In certain embodiments, the invention relates to any one of the aforementioned methods, wherein the plurality of sources are heated inlets; and said plurality of heated inlets transfers heat to said heated gaseous mixture.

In certain embodiments, the invention relates to any one of the aforementioned methods, wherein said heated gaseous mixture is at ambient temperature prior to passing through said plurality of heated inlets.

In certain embodiments, the invention relates to any one of the aforementioned methods, wherein while the heated gaseous mixture is confined in the interstitial volume the pressure in the interstitial volume is temporarily less than one atmosphere.

In certain embodiments, the invention relates to any one of the methods described herein, wherein the gaseous mixture further comprises a crosslinker. In certain embodiments, the crosslinker is selected from the group consisting of divinylbenzene, ethyleneglycol diacrylate, ethyleneglycol dimethacrylate, diethyleneglycol divinyl ether, diethyleneglycol dimethacrylate, diethyleneglycol diacrylate, 1,4-divinyloctafluorobutane, 2-methyl-1,5-hexadiene, 1,6-divinylperfluorohexane, 1,3-diisopropenylbenzene, 1,3-diethynylbenzene, 1,5-hexadiene, 1,6-heptadiene, 1,7-octadiene, 1,8-nonadiene, 1,9-decadiene, and 1H,1H,6H,6H-perfluorohexyldiacrylate, preferably divinylbenzene.

In certain embodiments, the invention relates to any one of the methods described herein, wherein said gaseous mixture of reagents further comprises an initiator. In certain embodiments, said initiator is a peroxide or an azo compound. In certain embodiments, wherein said initiator is an azo compound selected from the group consisting of 4,4′-Azobis(4-cyanovaleric acid), 4,4′-Azobis(4-cyanovaleric acid), 1,1′-Azobis(cyclohexanecarbonitrile), 2,2′-Azobis(2-methylpropionamidine) dihydrochloride, 2,2′-Azobis(2-methylpropionitrile), and 2,2′-Azobis(2-methylpropionitrile), preferably 2,2′-Azobis(2-methylpropionitrile). In certain embodiments, wherein said initiator is a peroxide selected from the group consisting of tert-butyl hydroperoxide, tert-butyl peracetate, cumene hydroperoxide, dicumyl peroxide, benzoyl peroxide, and tert-butyl peroxide.

In certain embodiments, the invention relates any one of the methods described herein, wherein the gaseous mixture further comprises a carrier gas.

In certain embodiments, the invention relates to any one of the methods described herein, wherein the unsaturated monomer is fluorinated. In certain embodiments, the unsaturated monomer is selected from the group consisting of divinylbenzene, 1,3-diethynylbenzene, phenylacetylene, glycidyl methacrylate, ethyleneglycol dimethacrylate, N,N-dimethylvinylbenzylamine, furfuryl methacrylate, 2-hydroxyethyl methacrylate, trivinyltrimethoxy-cyclotrisiloxane, methacrylic acid, 1,5-hexadiene, 1,6-heptadiene, 1,7-octadiene, 1,8-nonadiene, 1,9-decadiene, 4-vinyl pyridine, tert-butylacrylate, phenylacetylene, vinyl methacrylate, N,N-dimethylacrylamide, ethyleneglycol diacrylate, 1H,1H,2H,2H-Perfluorodecyl acrylate (PFDA), tridecafluorooctyl acrylate (FOA), 1,3-diisopropenylbenzene, 1H,1H,2H-Perfluoro-1-hexene, 1,4-Divinyloctafluorobutane, 2-Methyl-1,5-hexadiene, 1,6-divinylperfluorohexane, 3,4,4,5,5,5-Hexafluoro-3-(trifluoromethyl)pent-1-ene, 4,4,4-trifluoro-3,3-bis(trifluoromethyl)but-1-ene, 4,4,5,5,6,6,6-heptafluoro-3,3-bis(trifluoromethyl)-1-hexene, and pentafluorophenyl methacrylate, preferably 1H,1H,2H,2H-Perfluorodecyl acrylate (PFDA).

In certain embodiments, the invention relates to any one of the methods described herein, wherein the gaseous mixture further comprises an inhibitor. In certain embodiments, the inhibitor is selected from the group consisting of copper(II) chloride, 2,2-diphenyl-1-picrylhydrazyl (DPPH), 2,6-di-tert-butyl-α-(3,5-di-tert-butyl-4-oxo-2,5-cyclohexadien-1-ylidene)-p-tolyloxy (Galvinoxyl), TEMPO, 4-hydroxy TEMPO, Hydroquinone, and 2,5-di-tert-butylhydroquinone (DTBHQ), preferably 4-hydroxy TEMPO or DTBHQ.

In certain embodiments, the invention relates to any one of the methods described herein, wherein the article is a boiler or a reboiler.

In certain embodiments, the invention relates to any one of the methods described herein, wherein the article is a heat exchanger.

In certain embodiments, the invention relates any one of the methods described herein, wherein the heat exchanger is a power plant condenser.

### BRIEF DESCRIPTION OF THE DRAWINGS

FIG. 1 depicts a schematic representation of an exemplary embodiment of the coating method in which the coating precursors are flowed from a plurality of reservoirs into one space of a heat exchanger (e.g., shell side), and a heated fluid is flowed into a second space of the heat exchanger (e.g., tube side).

FIG. 2 depicts a schematic representation of an exemplary embodiment of the coating method in which the coating precursors are flowed from a plurality of reservoirs into one space of a heat exchanger after being heated by a heating section of the flow delivery system.

FIG. 3 depicts a schematic representation of another exemplary embodiment of the coating method in which the coating precursors are flowed from a plurality of reservoirs into one space of a heat exchanger (e.g., shell side) after being heated by a heating section of the flow delivery system, and a heated fluid is flowed into a second space of the heat exchanger (e.g., tube side).

### DETAILED DESCRIPTION OF THE INVENTION

Disclosed herein are methods to obtain a coating or film onto certain surfaces of an article by deposition from the vapor phase. The method is based on initiated chemical vapor deposition (iCVD). In a traditional iCVD process, thin filament wires are heated, thus supplying the energy to fragment a thermally-labile initiator. The methods disclosed herein, however, utilize thermal energy without the use of a filament to fragment the initiator. The method affords a coating that is extremely thin and that can be applied, if desired, to a fully-assembled device instead of individual parts before assembly.

A sealed volume provides a controlled environment for the coating deposition to occur on the desired surface. In certain embodiments, this may be accomplished with a chamber that encloses the surface. In certain embodiments, the surface may be inserted into an external chamber that completely or at least partially encloses the surface. In certain embodiments, a sealed environment may be obtained by attaching a piece of equipment to the exterior of a large surface to enclose a portion thereof. In certain embodiments, the sealed environment may be obtained by using the interior volume of the article to be coated. In certain embodiments, the chamber will consist of the shell of a heat exchanger for depositing a coating to surfaces inside the heat exchanger. In other embodiments, the inside of a tube may be used as the deposition chamber by capping the tube ends.

The interior surface may exist in many forms, including but not limited to: tubes, sheets, plates, wires, and fins. The interior surface may consist of a multitude of individual pieces, including a bundle of two or more tubes, an assembly of plates or sheets, or other arrangements. The surface material may be composed of: metal (such as stainless steel, copper, titanium, copper-nickel, brass, and others), plastic, ceramics, and other materials. The surface may be smooth or textured.

In certain embodiments, the invention relates to any one of the methods described herein, wherein while the gaseous mixture is confined in the interior volume of the article the pressure in the interior volume of the article is temporarily less than one atmosphere. In certain embodiments, evacuation may be performed with equipment in place. For example, an existing vacuum pump may be used for power plant condensers. In certain embodiments, the interior volume is at atmospheric pressure or has been purged with an inert gas (such as nitrogen or argon).

In certain embodiments, the deposition process may be considered a batch process in which the gaseous precursor vapors in the reaction chamber are largely stagnant. In certain embodiments, temporarily confining the gaseous mixture of reagents in the interior volume of the article after introduction may facilitate a batch process of depositing a coating. This arrangement will improve the uniformity of the polymer coating on the target surface(s) in the chamber, since it eliminates possible flow pattern effects typically seen in continuous flow processes.

Chemical vapor deposition (CVD) allows for use of any of a wide range of film compositions selected to best suit a particular application. For example, to achieve dropwise condensation of very low surface tension working fluids, such as solvents and refrigerants, it may be necessary to obtain a film with an even lower free surface energy. One way this can be accomplished is by incorporating low energy −CF₂ and −CF₃ functionalities into the film.

In certain embodiments, the invention relates to any one of the methods described herein, wherein the unsaturated monomer is fluorinated. In certain embodiments, the invention relate to any one of the methods herein, wherein the unsaturated monomer is selected from the group consisting of divinylbenzene, 1,3-diethynylbenzene, phenylacetylene, glycidyl methacrylate, ethyleneglycol dimethacrylate, N,N-dimethylvinylbenzylamine, furfuryl methacrylate, 2-hydroxyethyl methacrylate, trivinyltrimethoxy-cyclotrisiloxane, methacrylic acid, 1,5-hexadiene, 1,6-heptadiene, 1,7-octadiene, 1,8-nonadiene, 1,9-decadiene, 4-vinyl pyridine, tert-butylacrylate, phenylacetylene, vinyl methacrylate, N,N-dimethylacrylamide, ethyleneglycol diacrylate, 1H,1H,2H,2H-Perfluorodecyl acrylate (PFDA), tridecafluorooctyl acrylate (FOA), 1,3-diisopropenylbenzene, 1H,1H,2H-Perfluoro-1-hexene, 1,4-Divinyloctafluorobutane, 2-Methyl-1,5-hexadiene, 1,6-divinylperfluorohexane, 3,4,4,5,5,5-Hexafluoro-3-(trifluoromethyl)pent-1-ene, 4,4,4-trifluoro-3,3-bis(trifluoromethyl)but-1-ene, 4,4,5,5,6,6,6-heptafluoro-3,3-bis(trifluoromethyl)-1-hexene, and pentafluorophenyl methacrylate, preferably 1H,1H,2H,2H-Perfluorodecyl acrylate (PFDA).

In certain embodiments of the invention, a homopolymer may be sufficient to impart the desired film properties. In other embodiments of the invention, crosslinking is necessary to improve the durability and wetting properties of the film, in which case a second crosslinker vapor species may be incorporated into the film to form a copolymer. In certain embodiments, the invention relates to any one of the methods described herein, wherein the gaseous mixture further comprises a crosslinker. In certain embodiments, the invention relates to any one of the methods described herein, wherein the crosslinker is selected from the group consisting of divinylbenzene, ethyleneglycol diacrylate, ethyleneglycol dimethacrylate, diethyleneglycol divinyl ether, diethyleneglycol dimethacrylate, diethyleneglycol diacrylate, 1,4-divinyloctafluorobutane, 2-methyl-1,5-hexadiene, 1,6-divinylperfluorohexane, 1,3-diisopropenylbenzene, 1,3-diethynylbenzene, 1,5-hexadiene, 1,6-heptadiene, 1,7-octadiene, 1,8-nonadiene, 1,9-decadiene, and 1H,1H,6H,6H-perfluorohexyldiacrylate, preferably divinylbenzene.

In certain embodiments, the invention relates to any one of the methods described herein, wherein said gaseous mixture of reagents further comprises an initiator. In certain embodiments, the initiator is a peroxide or an azo compound. In certain embodiments, wherein said initiator is an azo compound selected from the group consisting of 4,4′-Azobis(4-cyanovaleric acid), 4,4′-Azobis(4-cyanovaleric acid), 1,1′-Azobis(cyclohexanecarbonitrile), 2,2′-Azobis(2-methylpropionamidine) dihydrochloride, 2,2′-Azobis(2-methylpropionitrile), and 2,2′-Azobis(2-methylpropionitrile). In certain embodiments, wherein said initiator is a peroxide selected from the group consisting of tert-butyl hydroperoxide, tert-butyl peracetate, cumene hydroperoxide, dicumyl peroxide, benzoyl peroxide, and tert-butyl peroxide.

In certain embodiments, the initiator is selected from the group consisting of ditert-butyl peroxide (TBPO), tert-butyl peracetate, cumene hydroperoxide, dicumyl peroxide, di-tert-amyl peroxide, tert-butyl peroxy benzoate, tent-amyl peroxy benzoate, tert-butyl hydroperoxide, tent-amyl hydroperoxide, 2,5-dimethylhexane-2,5-dihydroperoxide, 2,5-dimethyl-2,5-bis(tert-butyl peroxy)hexane, 2,5-dimethyl-2,5-di(tert-butylperoxy)hexyne-3, tert-butyl peroxyacetate, tert-butyl peroxydiethylacetate, tert-butyl monoperoxymaleate, tert-butyl peroxypivalate, tent-amyl peroxypivalate, tert-butyl peroxyneodecanoate, tert-amyl peroxyneodecanoate, tert-butyl peroxy-2-ethylhexanoate, tent-amyl peroxy-2-ethylhexanoate, tert-butyl peroxyisobutyrate, tert-butyl peroxyneoheptanoate, tert-butyl peroxy-3,5,5,-trimethyl hexanoate, tert-butyl peroxy-2-ethylhexyl carbonate, tent-amyl peroxy-2-ethylhexyl carbonate, 2,5-dimethyl-2,5-di(2-ethylhexanoylperoxy)hexane), 3,6,9-triethyl-3,6,9-trimethyl-1,4,7-triperoxynonane, 1,1,-di(tert-butylperoxy)-3,3,5-trimethylcyclohexane, 1,1,-di(tert-butylperoxy) cyclohexane, 2,2,-di(tert-butylperoxy) butane, di-benzoyl peroxide, di-(3,5,5,-trimethylhexanoyl) peroxide, dilauroyl peroxide, di(2-ethylhexyl) peroxydicarbonate, di(4-tert-butylcyclohexyl) peroxydicarbonate, dimyristyl peroxydicarbonate, dicetyl peroxydicarbonate, perfluoroctane sulfonyl fluoride (PFOS), perfluorobutane-1-sulfonyl fluoride (PFBS) , triethylamine (TEA), benzophenone, 2,2′-Azobis(4-methoxy-2.4-dimethyl valeronitrile), di(n-propyl) peroxydicarbonate, 2,2′-Azobisisobutyronitrile (AIBN), 2,2′-azobis (2-methylpropane), benzophenone, 4,4′-Azobis(4-cyanovaleric acid), 4,4′-Azobis(4-cyanovaleric acid), 1,1′-Azobis(cyclohexanecarbonitrile), 2,2′-Azobis(2-methylpropionamidine) dihydrochloride, 2,2′-Azobis(2-methylpropionitrile), and 2,2′-Azobis(2-methylpropionitrile) and combinations thereof.

In certain embodiments, thermal energy will be used to form free radicals. In certain embodiments, thermal energy may be introduced via direct contact with a heated substrate.

In certain embodiments, the invention relates to any one of the methods described herein, wherein prior to introduction of the gaseous mixture the interior surface of the article is heated. In certain embodiments, an electrical current is supplied to the target deposition surface to heat it to temperatures sufficient for activation of initiator. This can be accomplished by replacing a part from the heat exchanger with an electrically-isolated heater. In other embodiments, this can be accomplished by placing a current-carrying coil proximally to the surface to be heated, thereby generating an eddy current that generates heat within the target surface.

In certain embodiments, the deposition process is carried out by first pre-heating the entire chamber to elevated temperatures that are too high for appreciable precursor surface absorption. This can be accomplished by circulating a hot fluid through the interior volume. In other embodiments, this is accomplished by heaters placed externally or internally in the chamber. In some embodiments, the target deposition surfaces are subsequently cooled by passing cool water or cool air across their back surface or interior tube volume. In certain embodiments, the initial heated chamber then provides thermal energy for activation of the initiator which will then preferentially deposit on the target surfaces. In certain embodiments, the timing of the heating of the chamber and cooling of the target surfaces is critical to prevent condensation of the precursor vapors.

In certain embodiments, the deposition process is carried out by actively maintaining elevated wall temperatures and cooling the target deposition surfaces. This can be accomplished by heaters placed externally or internally in the chamber. The target deposition surfaces can be maintained at a lower temperature than the walls by flowing a cool fluid across their back surface, or interior tube volume in the case of a coated tube.

In certain embodiments, the fluid inside the tube will alternate between fluids with two different temperatures for initiation and deposition. In certain embodiments, a heating lance may be inserted through the exhaust manifold, or other location. In certain embodiments, a heated vapor manifold may be used, including but not limited to: a regular tube may be replaced by a “manifold tube”, and/or the vapor may pass over and/or through one or more heated filaments at the vapor inlet. In certain embodiments, an exothermic chemical reaction and/or combustion provides the energy for heating. In certain embodiments, mechanical friction provides the energy for heating. In certain embodiments, a hot carrier gas may be used, including but not limited to: steam or other process vapor, and/or inert gas. In certain embodiments, the carrier gas is nitrogen or argon

In certain embodiments, the temperatures required to obtain an appreciable rate of initiator thermal cleavage are often considerably higher than room temperature. For example, U.S. Patent Application Publication 2014/0314982 (hereby incorporated by reference) provides examples of iCVD depositions wherein the heated filament temperature is 230° C. At these higher temperatures, the corresponding vapor pressure of a given monomer species will be accordingly higher than at room temperature. Since the areal density of adsorbed monomer species on a surface at a given temperature and partial pressure is inversely proportional to the vapor pressure of the monomer species corresponding the substrate temperature, higher substrate temperatures result in lower adsorbed areal density for a given monomer partial pressure. Thus, in certain embodiments, when the target surface for polymer deposition is providing the thermal energy for initiator activation, it is necessary to maintain high partial pressures of the precursor to ensure sufficient surface concentration of the initiator and monomer precursor(s) at the elevated temperatures necessary to also activate the initiator species. This may be accomplished by introducing the monomer at a higher pressure, either by heating the monomer precursor or by other means of pressurization.

In certain embodiments, the invention relates to any one of the methods described herein, wherein prior to introduction into the interior volume of the article the temperature of the gaseous mixture is about 25° C. to about 50° C. In certain embodiments, prior to introduction into the interior volume of the article the temperature of the gaseous mixture is about 30° C. to about 45° C.

In certain embodiments, the pressure in the reaction chamber may be higher than the vapor pressure of the initiator and monomer precursor(s) at room temperature, since high partial pressures need to be maintained in the chamber and/or the precursors may have low saturation pressure at room temperature. If this occurs, precursor flow rates and delivery to the chamber may be negatively impacted. Two possible ways to increase flow rates include heating the precursor to increase the vapor pressure, and using a carrier gas. In certain embodiments, the invention relates to any one of the methods described herein, wherein the gaseous mixture further comprises a carrier gas. In certain embodiments, a carrier gas may be bubbled through the precursor liquid to carry the monomer(s) or initiator(s) into the chamber at high flow rates, in case the chamber pressure is higher than the vapor pressure of the precursor substance.

In certain embodiments, the monomer supply is heated to a high temperature to achieve a high vapor pressure and higher monomer flow rates. In certain embodiments, this may require an inhibitor to be mixed in with the liquid source monomer to minimize self-polymerization otherwise observed at these temperatures. Indeed, in certain embodiments, the invention relates to any one of the methods described herein, wherein the gaseous mixture further comprises an inhibitor. In certain embodiments, the inhibitor is selected from the group consisting of copper(II) chloride; 2,2-Diphenyl-1-picrylhydrazyl (DPPH); 2,6-Di-tert-butyl-α-(3,5-di-tert-butyl-4-oxo-2,5-cyclohexadien-1-ylidene)-p-tolyloxy (Galvinoxyl); TEMPO; 4-hydroxy TEMPO; Hydroquinone; 2,5-Di-tert-butylhydroquinone (DTBHQ), and combinations thereof.

In certain embodiments, the invention relates to any one of the methods described herein, wherein while temporarily confined in the interior volume of the article the gaseous mixture is heated to a temperature from about 50° C. to about 150° C. In certain embodiments, while temporarily confined in the interior volume of the article, the gaseous mixture is heated to a temperature from about 60° C. to about 130° C. In certain embodiments, while temporarily confined in the interior volume of the article, the gaseous mixture is heated to a temperature from about 70° C. to about 100° C.

In certain embodiments, a heated gaseous mixture is introduced into the interior volume of the article. In certain embodiments, the heated gaseous mixture is introduced at a temperature from about 50° C. to about 150° C. In certain embodiments, wherein the heated gaseous mixture is introduced at a temperature from about 60° C. to about 130° C. In certain embodiments, wherein the heated gaseous mixture is introduced at a temperature from about 70° C. to about 100° C. In certain embodiments, a heated inlet serves to transfer heat to the gaseous mixture. In certain embodiments a plurality of sources are heated inlets and serve to transfer the heated gaseous mixture.

In certain embodiments, the gaseous mixture is heated while temporarily confined in the interstitial volume. In certain embodiments, the gaseous mixture is heated to a temperature of about 50° C. to about 150° C. In certain embodiments, the gaseous mixture is heated to a temperature of about 60° C. to about 130° C. In certain embodiments, the gaseous mixture is heated to a temperature of about 70° C. to about 100° C. In certain embodiments, heat is applied to the confined gaseous mixture from the exterior surface of the article. In certain embodiments, the exterior surface of the article is heated prior to introduction of the gaseous mixture.

In certain embodiments, the gaseous mixture of reagents is introduced from a single source. In certain embodiments, the gaseous mixture is introduced from a plurality of sources.

In certain embodiments, the liquid reagent precursors are loaded into the interior volume of the article in set volumes and allowed to evaporate. Enhanced evaporation may be obtained using large exposed surface areas of the liquids, such as soaked meshes, large open areas, or other approaches. In certain embodiments, the rate of evaporation may also be increased by heating the liquid reagent precursors or bubbling an inert gas. In certain embodiments, the organic precursors are sprayed and/or aerosolized. In certain embodiments, the organic vapor inlet is located in the hotwell, and/or the exhaust duct, and/or the auxiliary line, and/or the manport, and/or by removing a tube from the bundle and inserting a manifold tube with perforations.

In certain embodiments, the deposition process is carried out by flowing the gaseous mixture of reagents into the chamber. In certain embodiments, this is accomplished by heating the reagents prior to or as they enter the chamber. In certain embodiments, this may be accomplished by heating the lines through which the reagents flow in moving between supply and the chamber. In certain embodiments, this may be accomplished by a heat source placed at the inlet port of the reagent lines to the chamber.

In certain embodiments, coating adhesion may be improved by using a grafting method. In one embodiment, this may be accomplished by plasma activation of the surface. In other embodiments, this may include exposure to methyl radicals formed by the decomposition of organic peroxides, exposure to silane compounds, exposure to thiols, and/or exposure to self-assembled monolayer compounds.

In certain embodiments, the invention relates to any one of the methods described herein, wherein the article is a boiler or a reboiler. In certain embodiments, the invention relates to any one of the methods described herein, wherein the article is a heat exchanger. In certain embodiments, the invention relates to any one of the methods described herein, wherein the heat exchanger is a power plant condenser.

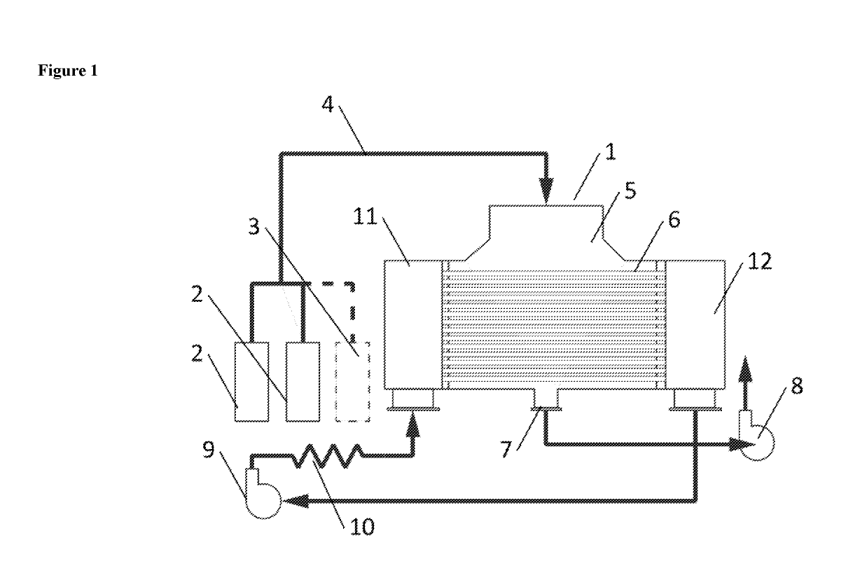

Referring now to FIG. 1, one embodiment is shown. Here, a condenser shell 1 is supplied with gaseous precursor species by one or more vapor delivery devices 2, 3. The vapor delivery inlet 4 delivers vapor species into the exhaust duct of the condenser 5 so that the shell of the condenser 1 and all of the condenser tubes 6 are in contact with the gaseous precursor species. A vacuum pump 8 is connected to the hotwell outlet 7 of the condenser to evacuate the condenser shell 1 prior to or during the deposition. The tubes 6 are maintained at an elevated temperature by using a pump 9 to pass a heat transfer fluid through a heating element 10 and into a waterbox 11 to be distributed throughout the tubes 6. The heated fluid is collected in the other waterbox 12 to be recirculated through the pump 9.

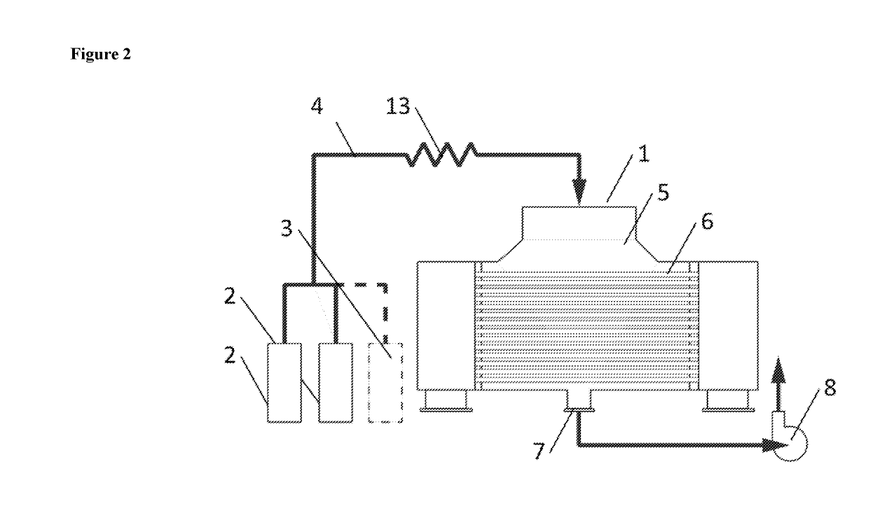

Referring now to FIG. 2, another embodiment is shown. Here, a condenser shell 1 is supplied with a gaseous mixture by one or more vapor delivery reservoirs 2, 3 by a supply line 4 that passes through a heater 13. The supply line delivers the heated mixture into the exhaust duct of the condenser 5 so that the shell of the condenser 1 and all of the condenser tubes 6 are in contact with the heated gaseous mixture. A vacuum pump 8 is connected to the hotwell outlet 7 of the condenser to evacuate the condenser shell 1 prior or during the deposition.

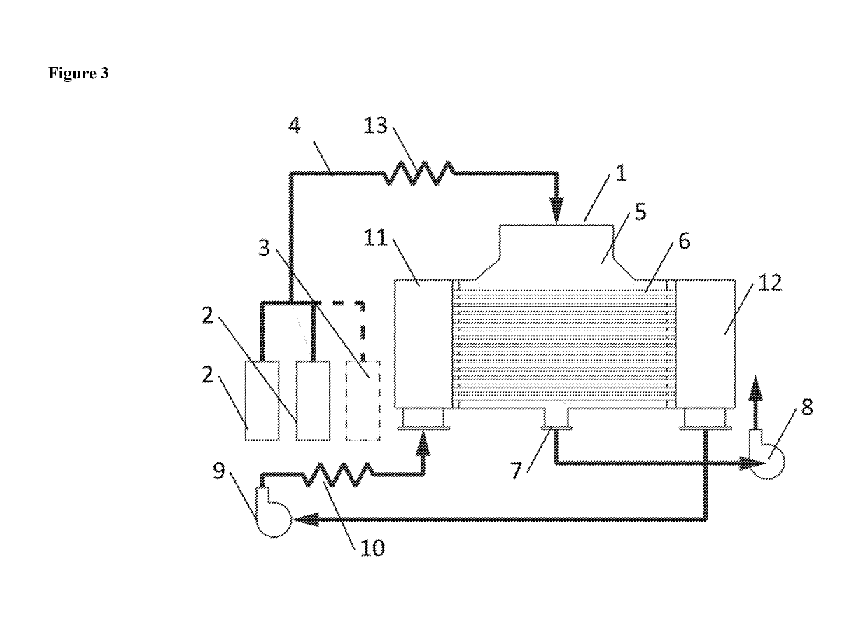

Referring now to FIG. 3, yet another embodiment is shown. Here, a condenser shell 1 is supplied with a gaseous mixture by one or more vapor delivery reservoirs 2, 3 by a supply line 4 that passes through a heater 13. The supply line delivers the heated mixture into the exhaust duct of the condenser 5 so that the shell of the condenser 1 and all of the condenser tubes 6 are in contact with the heated gaseous mixture. A vacuum pump 8 is connected to the hotwell outlet 7 of the condenser to evacuate the condenser shell 1 prior or during the deposition. The tubes 6 are maintained at an elevated temperature by using a pump 9 to pass a heat transfer fluid through a heating element 10 and into a waterbox 11 to be distributed throughout the tubes 6. The heated fluid is collected in the other waterbox 12 to be recirculated through the pump 9.

### EXEMPLIFICATION

The invention now being generally described, it will be more readily understood by reference to the following examples, which are included merely for purposes of illustration of certain aspects and embodiments of the present invention, and are not intended to limit the invention.

### Example 1

### Deposition Activated by a Heated Reactor Body

A polymeric coating was deposited onto a piece of silicon without the use of filaments. The deposition was carried out in a vacuum chamber in which the surface temperatures were controlled. The chamber was evacuated down to a base pressure of less than 0.05 Torr. All reactor chamber walls and surfaces were heated to around 150° C. The substrate surface was held at a temperature of about 35° C. Divinylbenzene (DVB) was used as the monomer, and preheated in a glass jar outside the reactor to 80° C. An inhibitor, 4-hydroxy TEMPO, was used to minimize self-polymerization of the DVB in the glass jar. A free radical initiator, di-tert-butylperoxide (TBPO), was also used. DVB and TBPO were flowed into the chamber through heated lines at 0.6 and 3.8 sccm, respectively. The throttle valve, which exhausts to the pump, was used to maintain the chamber pressure at 1.75 Torr. The reaction was allowed to proceed for 105 minutes. After this time, the chamber was evacuated and cooled down. The result was a thin polymer film (˜10 nm) on the substrate that was cloudy in appearance.

### Example 2

### Deposition Activated by Heated Substrate (Prophetic)

This example outlines an experiment to deposit a polymer coating without the use of filaments. The deposition is carried out in a vacuum chamber in which surface temperatures are controlled. The chamber is evacuated down to a base pressure of less than 0.05 Torr. The target surface within the chamber is heated to a temperature of 120° C. All other chamber walls and surfaces are heated to around 70° C. Divinylbenzene (DVB) is used as the monomer and heated in a glass jar outside the reactor to 80° C. An inhibitor is used to minimize the self-polymerization of the DVB in the glass jar. DVB is flowed into the vacuum chamber through heated lines. The throttle valve, which exhausts to the pump, is closed, and the chamber pressure increases due to DVB flow into the chamber. Once the pressure reaches 3 Torr, the DVB flow is stopped. A low-temperature free radical initiator, such as tert-butylperoxybenzoate (TBPOB), is then be delivered into the chamber using a carrier gas. The TBPOB/carrier gas flow continues until the total chamber pressure reaches 30 Torr. The flow of the TBPOB/carrier gas is then stopped. The reaction is allowed to proceed for 90 minutes. After this time, the chamber is evacuated and cooled down. This experiment results in a polymer film being deposited onto a target surface within the chamber.

### Example 3

### Deposition Activated by Heated Lines

This example outlines an experiment to deposit a polymer coating without the use of filaments. In this Example, polymerizations were conducted in a cylindrical vacuum chamber (described in Im, S.; Gleason. K.; Macromolecules, 2007, 40, 6552-6556). Heat tape (Omega Engineering) was used to heat the desired surfaces on the air side. The reactor body was maintained at 70° C., which was well below the activation temperature of the materials used. The target surface within the chamber was a Si wafer held to an inverted stage that was back-cooled at a temperature of ˜25° C. using a recirculating chiller (VWR). Reactor pressure was maintained at 2 Torr using a throttle valve (MKS Instruments). Di-tert-butylperoxide (TBPO) was used as the radical initiator and divinylbenzene (DVB) was used as the monomer. The TBPO was held in an unheated glass jar outside the reactor, and delivered to the chamber through lines heated at 180° C. and at a flowrate of 1.54 sccm using a needle valve. The DVB was heated in a glass jar to a temperature of 80° C., and it was delivered to the chamber through lines heated at 180° C. and at a flowrate of 0.4 sccm using a needle valve. After a deposition time of about 70 minutes, ˜2 nm of polymer film was deposited on the target surface.

### Incorporation by Reference

All of the cited U.S. Patents, U.S. patent application publications, and PCT patent application publications designating the U.S., are hereby incorporated by reference in their entirety.

### Equivalents

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto; the invention may be practiced otherwise than as specifically described and claimed.

What is claimed is:

1. A method of depositing a coating, comprising the steps of:
providing an article, wherein said article comprises an interior volume, an interior surface, and an exterior surface;
introducing a gaseous mixture of reagents into the interior volume of the article, wherein said gaseous mixture contacts said interior surface, and said gaseous mixture comprises a unsaturated monomer;
temporarily confining said gaseous mixture of reagents in the interior volume of the article; and
applying heat to the gaseous mixture of reagents temporarily confined in the interior volume of the article, thereby depositing a coating on said interior surface.

2. The method of claim 1, wherein the gaseous mixture further comprises a crosslinker.

3. The method of claim 1 or 2, wherein said gaseous mixture of reagents further comprises an initiator.

4. The method of any one of claims 1-3, wherein the gaseous mixture further comprises a carrier gas.

5. The method of any one of claims 1-4, wherein the unsaturated monomer is fluorinated.

6. The method of any one of claims 1-4, wherein the unsaturated monomer is selected from the group consisting of divinylbenzene, 1,3-diethynylbenzene, phenylacetylene, glycidyl methacrylate, ethyleneglycol dimethacrylate, N,N-dimethylvinylbenzylamine, furfuryl methacrylate, 2-hydroxyethyl methacrylate, trivinyltrimethoxy-cyclotrisiloxane, methacrylic acid, 1,5-hexadiene, 1,6-heptadiene, 1,7-octadiene, 1,8-nonadiene, 1,9-decadiene, 4-vinyl pyridine, tert-butylacrylate, phenylacetylene, vinyl methacrylate, N,N-dimethylacrylamide, ethyleneglycol diacrylate, 1H,1H,2H,2H-Perfluorodecyl acrylate (PFDA), tridecafluorooctyl acrylate (FOA), 1,3-diisopropenylbenzene, 1H,1H,2H-Perfluoro-1-hexene, 1,4-Divinyloctafluorobutane, 2-Methyl-1,5-hexadiene, 1,6-divinylperfluorohexane, 3,4,4,5,5,5-Hexafluoro-3-(trifluoromethyl)pent-1-ene, 4,4,4-trifluoro-3,3-bis(trifluoromethyl)but-1-ene, 4,4,5,5,6,6,6-heptafluoro-3,3-bis(trifluoromethyl)-1-hexene, and pentafluorophenyl methacrylate.

7. The method of claim 6, wherein the unsaturated monomer is 1H,1H,2H,2H-Perfluorodecyl acrylate (PFDA).

8. The method of any one of claims 1-7, wherein the crosslinker is selected from the group consisting of divinylbenzene, ethyleneglycol diacrylate, ethyleneglycol dimethacrylate, diethyleneglycol divinyl ether, diethyleneglycol dimethacrylate, diethyleneglycol diacrylate, 1,4-divinyloctafluorobutane, 2-methyl-1,5-hexadiene, 1,6-divinylperfluorohexane, 1,3-diisopropenylbenzene, 1,3-diethynylbenzene, 1,5-hexadiene, 1,6-heptadiene, 1,7-octadiene, 1,8-nonadiene, 1,9-decadiene, and 1H,1H,6H,6H-perfluorohexyldiacrylate.

9. The method of claim 8, wherein the crosslinker is divinylbenzene.

10. The method of any one of claims 3-9, wherein said initiator is a peroxide or an azo compound.

11. The method of claim 10, wherein said initiator is an azo compound selected from the group consisting of 4,4′-Azobis(4-cyanovaleric acid), 4,4′-Azobis(4-cyanovaleric acid), 1,1′-Azobis(cyclohexanecarbonitrile), 2,2′-Azobis(2-methylpropionamidine) dihydrochloride, 2,2′-Azobis(2-methylpropionitrile), and 2,2′-Azobis(2-methylpropionitrile).

12. The method of claim 11, wherein said initiator is 2,2′-Azobis(2-methylpropionitrile).

13. The method of claim 10, wherein said initiator is a peroxide selected from the group consisting of tert-butyl hydroperoxide, tert-butyl peracetate, cumene hydroperoxide, dicumyl peroxide, benzoyl peroxide, and tert-butyl peroxide.

14. The method of any one of claims 1-13, wherein while temporarily confined in the interior volume of the article the gaseous mixture is heated to a temperature from about 50° C. to about 150° C.

15. The method of claim 14, wherein while temporarily confined in the interior volume of the article the gaseous mixture is heated to a temperature from about 60° C. to about 130° C.

16. The method of claim 15, wherein while temporarily confined in the interior volume of the article the gaseous mixture is heated to a temperature from about 70° C. to about 100° C.

17. The method of any one of claims 1-16, wherein heat is applied to the confined gaseous mixture from the interior surface of the article.

18. The method of any one of claims 1-17, further comprising heating the interior surface of the article prior to introduction of the gaseous mixture.

19. The method of any one of claims 1-18, further comprising heating the gaseous mixture prior to introduction.

20. The method of any one of claims 1-19, wherein the gaseous mixture is introduced from a single source.

21. The method of any one of claims 1-19, wherein the gaseous mixture is introduced from a plurality of sources.

22. The method of any one of claims 1-21, wherein prior to introduction into the interior volume of the article the temperature of the gaseous mixture is about 25° C. to about 50° C.

23. The method of claim 22, wherein prior to introduction into the interior volume of the article the temperature of the gaseous mixture is about 30° C. to about 45° C.

24. The method of any one of claims 1-23, wherein while the gaseous mixture is confined in the interior volume of the article the pressure in the interior volume of the article is temporarily less than one atmosphere.

25. The method of any one of claims 1-24, wherein the article is a boiler or a reboiler.

26. The method of any one of claims 1-24, wherein the article is a heat exchanger.

27. The method of claim 26, wherein the heat exchanger is a power plant condenser.

28. The method of any one of claims 1-27, wherein the gaseous mixture further comprises an inhibitor.

29. The method of claim 28, wherein the inhibitor is selected from the group consisting of copper(II) chloride, 2,2-diphenyl-1-picrylhydrazyl (DPPH), 2,6-di-tert-butyl-α-(3,5-di-tert-butyl-4-oxo-2,5-cyclohexadien-1-ylidene)-p-tolyloxy (Galvinoxyl), TEMPO, 4-hydroxy TEMPO, Hydroquinone, and 2,5-di-tert-butylhydroquinone (DTBHQ).

30. The method of claim 29, wherein the inhibitor is 4-hydroxy TEMPO or DTBHQ.

31. A method of depositing a coating, comprising the steps of:
providing an article, wherein said article comprises an interior volume, an interior surface, and an exterior surface; and
introducing a heated gaseous mixture of reagents into the interior volume of the article, thereby depositing a coating on said interior surface; wherein said heated gaseous mixture is introduced at a temperature from about 50° C. to about 350° C.; said heated gaseous mixture contacts said interior surface; and said heated gaseous mixture comprises a unsaturated monomer.

32. The method of claim 31, wherein the heated gaseous mixture further comprises a crosslinker.

33. The method of claim 31 or 32, wherein said heated gaseous mixture of reagents further comprises an initiator.

34. The method of any one of claims 31-33, wherein the heated gaseous mixture further comprises a carrier gas.

35. The method of any one of claims 31-34, wherein the unsaturated monomer is fluorinated.

36. The method of any one of claims 31-34, wherein the unsaturated monomer is selected from the group consisting of divinylbenzene, 1,3-diethynylbenzene, phenylacetylene, glycidyl methacrylate, ethyleneglycol dimethacrylate, N,N-dimethylvinylbenzylamine, furfuryl methacrylate, 2-hydroxyethyl methacrylate, trivinyltrimethoxy-cyclotrisiloxane, methacrylic acid, 1,5-hexadiene, 1,6-heptadiene, 1,7-octadiene, 1,8-nonadiene, 1,9-decadiene, 4-vinyl pyridine, tert-butylacrylate, phenylacetylene, vinyl methacrylate, N,N-dimethylacrylamide, ethyleneglycol diacrylate, 1H,1H,2H,2H-Perfluorodecyl acrylate (PFDA), tridecafluorooctyl acrylate (FOA), 1,3-diisopropenylbenzene, 1H,1H,2H-Perfluoro-1-hexene, 1,4-Divinyloctafluorobutane, 2-Methyl-1,5-hexadiene, 1,6-divinylperfluorohexane, 3,4,4,5,5,5-Hexafluoro-3-(trifluoromethyl)pent-1-ene, 4,4,4-trifluoro-3,3-bis(trifluoromethyl)but-1-ene, 4,4,5,5,6,6,6-heptafluoro-3,3-bis(trifluoromethyl)-1-hexene, and pentafluorophenyl methacrylate.

37. The method of claim 36, wherein the unsaturated monomer is 1H,1H,2H,2H-Perfluorodecyl acrylate (PFDA).

38. The method of any one of claims 31-37, wherein the crosslinker is selected from the group consisting of divinylbenzene, ethyleneglycol diacrylate, ethyleneglycol dimethacrylate, diethyleneglycol divinyl ether, diethyleneglycol dimethacrylate, diethyleneglycol diacrylate, 1,4-divinyloctafluorobutane, 2-methyl-1,5-hexadiene, 1,6-divinylperfluorohexane, 1,3-diisopropenylbenzene, 1,3-diethynylbenzene, 1,5-hexadiene, 1,6-heptadiene, 1,7-octadiene, 1,8-nonadiene, 1,9-decadiene, and 1H,1H,6H,6H-perfluorohexyldiacrylate.

39. The method of claim 38, wherein the crosslinker is divinylbenzene.

40. The method of any one of claims 33-39, wherein said initiator is a peroxide or an azo compound.

41. The method of claim 40, wherein said initiator is an azo compound selected from the group consisting of 4,4′-Azobis(4-cyanovaleric acid), 4,4′-Azobis(4-cyanovaleric acid), 1,1′-Azobis(cyclohexanecarbonitrile), 2,2′-Azobis(2-methylpropionamidine) dihydrochloride, 2,2′-Azobis(2-methylpropionitrile), and 2,2′-Azobis(2-methylpropionitrile).

42. The method of claim 41, wherein said initiator is 2,2′-Azobis(2-methylpropionitrile).

43. The method of claim 40, wherein said initiator is a peroxide selected from the group consisting of tert-butyl hydroperoxide, tert-butyl peracetate, cumene hydroperoxide, dicumyl peroxide, benzoyl peroxide, and tert-butyl peroxide.

44. The method of any one of claims 31-43, wherein the heated gaseous mixture is introduced at a temperature from about 50° C. to about 150° C.

45. The method of claim 44, wherein the heated gaseous mixture is introduced at a temperature from about 60° C. to about 130° C.

46. The method of claim 45, wherein the heated gaseous mixture is introduced at a temperature from about 70° C. to about 100° C.

47. The method of any one of claims 31-46, further comprising heating the interior surface of the article prior to introduction of the heated gaseous mixture.

48. The method of any one of claims 31-47, wherein the heated gaseous mixture is introduced from a single source.

49. The method of claim 48, wherein said single source is a heated inlet; and said heated inlet transfers heat to said heated gaseous mixture.

50. The method of claim 49, wherein said heated gaseous mixture is at ambient temperature prior to passing through said heated inlet.

51. The method of any one of claims 31-47, wherein the heated gaseous mixture is introduced from a plurality of sources.

52. The method of claim 51, wherein the plurality of sources are heated inlets; and said plurality of heated inlets transfers heat to said heated gaseous mixture.

53. The method of claim 52, wherein said heated gaseous mixture is at ambient temperature prior to passing through said plurality of heated inlets.

54. The method of any one of claims 31-53, wherein while the heated gaseous mixture is confined in the interior volume of the article the pressure in the interior volume of the article is temporarily less than one atmosphere.

55. The method of any one of claims 31-54, wherein the article is a boiler or a reboiler.

56. The method of any one of claims 31-54, wherein the article is a heat exchanger.

57. The method of claim 56, wherein the heat exchanger is a power plant condenser.

58. The method of any one of claims 31-57, wherein the heated gaseous mixture further comprises an inhibitor.

59. The method of claim 58, wherein the inhibitor is selected from the group consisting of copper(II) chloride, 2,2-diphenyl-1-picrylhydrazyl (DPPH), 2,6-di-tert-butyl-α-(3,5-di-tert-butyl-4-oxo-2,5-cyclohexadien-1-ylidene)-p-tolyloxy (Galvinoxyl), TEMPO, 4-hydroxy TEMPO, Hydroquinone, and 2,5-di-tert-butylhydroquinone (DTBHQ).

60. The method of claim 59, wherein the inhibitor is 4-hydroxy TEMPO or DTBHQ.

61. The method of any one of claims 31-60, further comprising the step of temporarily confining said heated gaseous mixture of reagents in the interior volume of the article.

62. A method of depositing a coating, comprising the steps of:
providing an article and a housing; wherein said article comprises an exterior surface; said housing comprises an interior surface and an interior volume; and said article is positioned within said interior volume of said housing, thereby forming an interstitial volume between said exterior surface of said article and said interior surface of said housing;
introducing a gaseous mixture of reagents into the interstitial volume, wherein said gaseous mixture contacts said exterior surface of said article, and said gaseous mixture comprises a unsaturated monomer;
temporarily confining said gaseous mixture of reagents in the interstitial volume; and
applying heat to the gaseous mixture of reagents temporarily confined in the interstitial volume, thereby depositing a coating on said exterior surface of said article.

63. The method of claim 62, wherein the gaseous mixture further comprises a crosslinker.

64. The method of claim 62 or 63, wherein said gaseous mixture of reagents further comprises an initiator.

65. The method of any one of claims 62 -64, wherein the gaseous mixture further comprises a carrier gas.

66. The method of any one of claims 62-65, wherein the unsaturated monomer is fluorinated.

67. The method of any one of claims 62-65, wherein the unsaturated monomer is selected from the group consisting of divinylbenzene, 1,3-diethynylbenzene, phenylacetylene, glycidyl methacrylate, ethyleneglycol dimethacrylate, N,N-dimethylvinylbenzylamine, furfuryl methacrylate, 2-hydroxyethyl methacrylate, trivinyltrimethoxy-cyclotrisiloxane, methacrylic acid, 1,5-hexadiene, 1,6-heptadiene, 1,7-octadiene, 1,8-nonadiene, 1,9-decadiene, 4-vinyl pyridine, tert-butylacrylate, phenylacetylene, vinyl methacrylate, N,N-dimethylacrylamide, ethyleneglycol diacrylate, 1H,1H,2H,2H-Perfluorodecyl acrylate (PFDA), tridecafluorooctyl acrylate (FOA), 1,3-diisopropenylbenzene, 1H,1H,2H-Perfluoro-1-hexene, 1,4-Divinyloctafluorobutane, 2-Methyl-1,5-hexadiene, 1,6-divinylperfluorohexane, 3,4,4,5,5,5-Hexafluoro-3-(trifluoromethyl)pent-1-ene, 4,4,4-trifluoro-3,3-bis(trifluoromethyl)but-1-ene, 4,4,5,5,6,6,6-heptafluoro-3,3-bis(trifluoromethyl)-1-hexene, and pentafluorophenyl methacrylate.

68. The method of claim 67, wherein the unsaturated monomer is 1H,1H,2H,2H-Perfluorodecyl acrylate (PFDA).

69. The method of any one of claims 62-68, wherein the crosslinker is selected from the group consisting of divinylbenzene, ethyleneglycol diacrylate, ethyleneglycol dimethacrylate, diethyleneglycol divinyl ether, diethyleneglycol dimethacrylate, diethyleneglycol diacrylate, 1,4-divinyloctafluorobutane, 2-methyl-1,5-hexadiene, 1,6-divinylperfluorohexane, 1,3-diisopropenylbenzene, 1,3-diethynylbenzene, 1,5-hexadiene, 1,6-heptadiene, 1,7-octadiene, 1,8-nonadiene, 1,9-decadiene, and 1H,1H,6H,6H-perfluorohexyldiacrylate.

70. The method of claim 69, wherein the crosslinker is divinylbenzene.

71. The method of any one of claims 64-70, wherein said initiator is a peroxide or an azo compound.

72. The method of claim 71, wherein said initiator is an azo compound selected from the group consisting of 4,4′-Azobis(4-cyanovaleric acid), 4,4′-Azobis(4-cyanovaleric acid), 1,1′-Azobis(cyclohexanecarbonitrile), 2,2′-Azobis(2-methylpropionamidine) dihydrochloride, 2,2′-Azobis(2-methylpropionitrile), and 2,2′-Azobis(2-methylpropionitrile).

73. The method of claim 72, wherein said initiator is 2,2′-Azobis(2-methylpropionitrile).

74. The method of claim 71, wherein said initiator is a peroxide selected from the group consisting of tert-butyl hydroperoxide, tert-butyl peracetate, cumene hydroperoxide, dicumyl peroxide, benzoyl peroxide, and tert-butyl peroxide.

75. The method of any one of claims 62-74, wherein while temporarily confined in the interstitial volume the gaseous mixture is heated to a temperature from about 50° C. to about 150° C.

76. The method of claim 75, wherein while temporarily confined in the interstitial volume the gaseous mixture is heated to a temperature from about 60° C. to about 130° C.

77. The method of claim 76, wherein while temporarily confined in the interstitial volume the gaseous mixture is heated to a temperature from about 70° C. to about 100° C.

78. The method of any one of claims 62-77, wherein heat is applied to the confined gaseous mixture from the exterior surface of the article.

79. The method of any one of claims 62-78, further comprising heating the exterior surface of the article prior to introduction of the gaseous mixture.

80. The method of any one of claims 62-79, further comprising heating the gaseous mixture prior to introduction.

81. The method of any one of claims 62-80, wherein the gaseous mixture is introduced from a single source.

82. The method of any one of claims 62-80, wherein the gaseous mixture is introduced from a plurality of sources.

83. The method of any one of claims 62-82, wherein prior to introduction into the interstitial volume the temperature of the gaseous mixture is about 25° C. to about 50° C.

84. The method of claim 83, wherein prior to introduction into the interstitial volume the temperature of the gaseous mixture is about 30° C. to about 45° C.

85. The method of any one of claims 63-84, wherein while the gaseous mixture is confined in the interstitial volume the pressure in the interstitial volume is temporarily less than one atmosphere.

86. The method of any one of claims 63-85, wherein the article is a boiler or a reboiler.

87. The method of any one of claims 63-85, wherein the article is a heat exchanger.

88. The method of claim 87, wherein the heat exchanger is a power plant condenser.

89. The method of any one of claims 63-88, wherein the gaseous mixture further comprises an inhibitor.

90. The method of claim 89, wherein the inhibitor is selected from the group consisting of copper(II) chloride, 2,2-diphenyl-1-picrylhydrazyl (DPPH), 2,6-di-tert-butyl-α-(3,5-di-tert-butyl-4-oxo-2,5-cyclohexadien-1-ylidene)-p-tolyloxy (Galvinoxyl), TEMPO, 4-hydroxy TEMPO, Hydroquinone, and 2,5-di-tert-butylhydroquinone (DTBHQ).

91. The method of claim 90, wherein the inhibitor is 4-hydroxy TEMPO or DTBHQ.

92. A method of depositing a coating, comprising the steps of:
providing an article and a housing; wherein said article comprises an exterior surface; said housing comprises an interior surface and an interior volume; and said article is positioned within said interior volume of said housing, thereby forming an interstitial volume between said exterior surface of said article and said interior surface of said housing;
introducing a heated gaseous mixture of reagents into the interstitial volume, thereby depositing a coating on said exterior surface of said article; wherein said heated gaseous mixture is introduced at a temperature from about 50° C. to about 350° C.; said heated gaseous mixture contacts said exterior surface of said article; and said heated gaseous mixture comprises a unsaturated monomer.

93. The method of claim 92, wherein the heated gaseous mixture further comprises a crosslinker.

94. The method of claim 92 or 93, wherein said heated gaseous mixture of reagents further comprises an initiator.

95. The method of any one of claims 92-94, wherein the heated gaseous mixture further comprises a carrier gas.

96. The method of any one of claims 92-95, wherein the unsaturated monomer is fluorinated.

97. The method of any one of claims 92-95, wherein the unsaturated monomer is selected from the group consisting of divinylbenzene, 1,3-diethynylbenzene, phenylacetylene, glycidyl methacrylate, ethyleneglycol dimethacrylate, N,N-dimethylvinylbenzylamine, furfuryl methacrylate, 2-hydroxyethyl methacrylate, trivinyltrimethoxy-cyclotrisiloxane, methacrylic acid, 1,5-hexadiene, 1,6-heptadiene, 1,7-octadiene, 1,8-nonadiene, 1,9-decadiene, 4-vinyl pyridine, tert-butylacrylate, phenylacetylene, vinyl methacrylate, N,N-dimethylacrylamide, ethyleneglycol diacrylate, 1H,1H,2H,2H-Perfluorodecyl acrylate (PFDA), tridecafluorooctyl acrylate (FOA), 1,3-diisopropenylbenzene, 1H,1H,2H-Perfluoro-1-hexene, 1,4-Divinyloctafluorobutane, 2-Methyl-1,5-hexadiene, 1,6-divinylperfluorohexane, 3,4,4,5,5,5-Hexafluoro-3-(trifluoromethyl)pent-1-ene, 4,4,4-trifluoro-3,3-bis(trifluoromethyl)but-1-ene, 4,4,5,5,6,6,6-heptafluoro-3,3-bis(trifluoromethyl)-1-hexene, and pentafluorophenyl methacrylate.

98. The method of claim 97, wherein the unsaturated monomer is 1H,1H,2H,2H-Perfluorodecyl acrylate (PFDA).

99. The method of any one of claims 92-98, wherein the crosslinker is selected from the group consisting of divinylbenzene, ethyleneglycol diacrylate, ethyleneglycol dimethacrylate, diethyleneglycol divinyl ether, diethyleneglycol dimethacrylate, diethyleneglycol diacrylate, 1,4-divinyloctafluorobutane, 2-methyl-1,5-hexadiene, 1,6-divinylperfluorohexane, 1,3-diisopropenylbenzene, 1,3-diethynylbenzene, 1,5-hexadiene, 1,6-heptadiene, 1,7-octadiene, 1,8-nonadiene, 1,9-decadiene, and 1H,1H,6H,6H-perfluorohexyldiacrylate.

100. The method of claim 99, wherein the crosslinker is divinylbenzene.

101. The method of any one of claims 94-100, wherein said initiator is a peroxide or an azo compound.

102. The method of claim 101, wherein said initiator is an azo compound selected from the group consisting of 4,4′-Azobis(4-cyanovaleric acid), 4,4′-Azobis(4-cyanovaleric acid), 1,1′-Azobis(cyclohexanecarbonitrile), 2,2′-Azobis(2-methylpropionamidine) dihydrochloride, 2,2′-Azobis(2-methylpropionitrile), and 2,2′-Azobis(2-methylpropionitrile).

103. The method of claim 102, wherein said initiator is 2,2′-Azobis(2-methylpropionitrile).

104. The method of claim 101, wherein said initiator is a peroxide selected from the group consisting of tert-butyl hydroperoxide, tert-butyl peracetate, cumene hydroperoxide, dicumyl peroxide, benzoyl peroxide, and tert-butyl peroxide.

105. The method of any one of claims 92-104, wherein the heated gaseous mixture is introduced at a temperature from about 50° C. to about 150° C.

106. The method of claim 105, wherein the heated gaseous mixture is introduced at a temperature from about 60° C. to about 130° C.

107. The method of claim 106, wherein the heated gaseous mixture is introduced at a temperature from about 70° C. to about 100° C.

108. The method of any one of claims 92-107, further comprising heating the exterior surface of the article prior to introduction of the heated gaseous mixture.

109. The method of any one of claims 92-108, wherein the heated gaseous mixture is introduced from a single source.

110. The method of claim 109, wherein said single source is a heated inlet; and said heated inlet transfers heat to said heated gaseous mixture.

111. The method of claim 110, wherein said heated gaseous mixture is at ambient temperature prior to passing through said heated inlet.

112. The method of any one of claims 92-108, wherein the heated gaseous mixture is introduced from a plurality of sources.

113. The method of claim 112, wherein the plurality of sources are heated inlets; and said plurality of heated inlets transfers heat to said heated gaseous mixture.

114. The method of claim 113, wherein said heated gaseous mixture is at ambient temperature prior to passing through said plurality of heated inlets.

115. The method of any one of claims 92-114, wherein while the heated gaseous mixture is confined in the interstitial volume the pressure in the interstitial volume is temporarily less than one atmosphere.

116. The method of any one of claims 92-115, wherein the article is a boiler or a reboiler.

117. The method of any one of claims 92-115, wherein the article is a heat exchanger.

118. The method of claim 117, wherein the heat exchanger is a power plant condenser.

119. The method of any one of claims 92-118, wherein the heated gaseous mixture further comprises an inhibitor.

120. The method of claim 119, wherein the inhibitor is selected from the group consisting of copper(II) chloride, 2,2-diphenyl-1-picrylhydrazyl (DPPH), 2,6-di-tert-butyl-α-(3,5-di-tert-butyl-4-oxo-2,5-cyclohexadien-1-ylidene)-p-tolyloxy (Galvinoxyl), TEMPO, 4-hydroxy TEMPO, Hydroquinone, and 2,5-di-tert-butylhydroquinone (DTBHQ).

121. The method of claim 120, wherein the inhibitor is 4-hydroxy TEMPO or DTBHQ.

122. The method of any one of claims 92-121, further comprising the step of temporarily confining said heated gaseous mixture of reagents in the interstitial volume.
